(19) United States
(12) Patent Application Publication
(10) Pub. No.: US 2002/0061064 A1
(43) Pub. Date: May 23, 2002

(54) Video broadcasting equipment, image processing equipment, and camera

(76) Inventors: Fumio Ishikawa, Kawasaki (JP); Hirobumi Kawamura, Kawasaki (JP)

Correspondence Address: ROSENMAN & COLIN LLP, 575 MADISON AVENUE, NEW YORK, NY, 10022-2585, US

(21) Appl. No.: 09/817,069

(22) Filed: Mar. 26, 2001

(30) Foreign Application Priority Data
Nov. 22, 2000 (JP) 2000-355515

(51) Int. Cl. H04N 7/12; H04N 7/18

(52) U.S. Cl. 375/240.12; 348/143; 348/153; 348/159; 348/169

(57) ABSTRACT

The invention relates to a video broadcasting equipment for downloading image information given from a camera to an image processing equipment, the image processing equipment which accomplishes centralized supervisory of image information, and the camera. The video broadcasting equipment discriminates a dynamic region of image information individually representing an image of a coverage of a camera and transmits the image information and a discrimination result of the dynamic region to the image processing equipment through a communication path. In the centralized supervisory system to which the present invention is applied, traffic on a communication path formed to the cameras does not increase, and image information to be subjected to dynamic image processing is specified according to a result of processing of discriminating the dynamic region. The discrimination processing is generally simple and its throughput is substantially small in comparison with the dynamic image processing.

### BACKGROUND OF THE INVENTION

1. Field of the Invention

This invention relates to video broadcasting equipment for downloading image information given from cameras to image processing equipment for achieving centralized supervisory of the image information, and to the image processing equipment and cameras.

2. Description of the Related Art

video transmission technologies and information processing technologies have made remarkable progress in recent years and peripheral technologies for reducing the cost of necessary appliances and equipment have been established. Therefore, these technologies have been applied widely to imaging systems facilitating centralized supervisory of remote and unfrequented places and dangerous places as visual information, such as a system for assisting management of roads, rivers, traffics, buildings and others.

FIG. 8 of the accompanying drawings illustrates a structural example of a video monitoring system.

In the drawing, a plurality of cameras 60-1 to 60-N are connected to a network 80 through terminal equipment 70-1 to 70-N, respectively, and a video monitoring center 90 is connected to the network 80.

The terminal equipment 70-1 includes a video coding part 71-1, an advanced image processing part 72-1 and a network interfacing part 73-1 that are cascaded between the camera 60-1 and the network 80, and a controlling part 74-1 having input/output ports individually connected to control terminals of these video coding part 71-1, advanced image processing part 72-1 and network interfacing part 73-1.

The construction of the terminal equipment 70-2 to 70-N is the same as that of the terminal equipment 70-1. Therefore, reference numeral with a suffix “2” to “N”, that replaces the suffix “1”, will be allocated to the corresponding constituent and its explanation and illustration will be omitted.

Also, suffix “C”, that is applicable to any of the suffixes “I” to “N”, will be allocated to the common matter of the terminal equipment 70-1 to 70-N in the following description.

The video monitoring center 90 includes a video decoding part 91 connected to the network 80, an advanced image processing part 92 and a visual display 93 that are cascaded with the video decoding part 91, and a controlling part 94 having input/output ports connected indivdually to control terminals of these video decoding part 91 and advanced image processing part 92.

In the video monitoring system having such a construction, the network interfacing part 73-C provided to the terminal equipment 70-C forms in advance a predetermined path between itself and the video monitoring center 90 (video decoding part 91) through the network 80.

The interlinking procedure between the network interfacing part 73-C and the video decoding part 91 during the formation process of such a path on the basis of a signaling system and a communication protocol suitable for the network 80 does not constitute the gist of the present invention but can be accomplished by various known technologies. Therefore, the explanation of such a procedure is hereby omitted.

The video coding part 71-C codes the image signal given from the camera 60-C in accordance with a predetermined coding system (which will be hereby assumed to be an MPEG system and wherein a compression rate is directed by the controlling part 74-Q, and generates image information representing the image signal in a digital domain.

The advanced video coding part 72-C applies dynamic image processing to this image information in order to acquire various information and detect an event only when an instruction to execute the dynamic image processing (advanced image processing) is given by the controlling part 74-C.

During this dynamic image processing, the whole, or a part, of the following processing is executed.

a processing which determines interframe correlation, background difference, etc, and detects that any object enters a coverage of the camera 60-C and an object previously positioned in this coverage moves or disappears;

a processing which computes the whole, or a part, of the shape, size and moving speed (inclusive of the moving direction) of the object described above on the basis of the train of the results of the interframe correlation, background difference, etc, and resolution for each pixel in the coverage of the camera 60-C; and

a processing which generates new image information created by superimposing the whole, or a desired part, of the detected object and the shape, size and moving speed of the object as image information with the image information generated by the video coding part 71-C.

The network interfacing part 73 multiplexes the image information given through the advanced image processing part 72-C with a message representing the detection of the object described above as the event and serially transmits them or serially transmits only one of them to the video monitoring center 90 through the path.

In the video monitoring center 90, the video decoding part 91 selects a specific signal assigned under a man-machine interface executed by the controlling part 94 among the signals received in parallel through the paths individually formed to the terminal equipment 70-1 to 70-N.

The video decoding part 91 executes a de-multiplexing processing opposite to the multiplexing processing executed by the network interfacing part 73-C provided to the terminal equipment 70-C for the selected signal and a decoding processing adaptive to the coding system executed by the video coding part 71-C under initiative of the controlling part 94, and appropriately decodes the image information and the message.

The advanced image processing part 92 gives, to the visual display 93, the decoded image information where no image processing is performed, or image information which is generated by performing the above dynamic image processing on the decoded image information.

Incidentally, the dynamic image processing is fundamentally the same as the aforementioned dynamic image processing executed by the advanced image processing part 72-C provided to the terminal equipment 70-C. Therefore, its detailed explanation is omitted.

Therefore, the message obtained by the application of the dynamic image processing to the image of the desired coverage and the condition of this coverage among the coverages imaged individually by the cameras 60-1 to 60-C installed individually at remote places through the network 80 can be displayed as the visual information on the substantial real time basis.

In the prior art example described above, the advanced image processing parts 72-1 to 72-N are provided to the terminal equipment 70-1 to 70-N, respectively. Therefore, the hardware scale of the terminal equipment 70-1 to 70-N becomes great, the cost becomes high and reliability may drop.

In the video monitoring center 90, the number of minimum image information downloaded from the terminal equipment 70-1 to 70-N and satisfying the requirements for centralized supervisory and remote supervisory is great. To execute the dynamic image processing in parallel with these image information, the throughput to be secured in the advanced image processing part 92 becomes enormous, inviting thereby various limitations to the cost, reliability, packaging property, maintenance, operation, and so forth. In practice, therefore, the load of the dynamic image processing must be dispersed in many cases to the terminal equipment 70-1 to 70-N.

### SUMMARY OF THE INVENVION

It is an object of the present invention to provide a video broadcasting equipment, an image processing equipment, and a camera which have simplified construction and are capable of simplifying a construction and reliably accomplishing a dynamic image processing.

It is another object of the present invention to execute a dynamic image processing only on image information suitable for an object of the dynamic image processing in individual video broadcasting equipments; to secure performance required for video monitoring; and to simplify the construction and reduce a cost, in comparison with a prior art example wherein the dynamic image processing is uselessly performed on all the image information.

It is another object of the present invention to lower traffic on a communication path formed to an image processing equipment and a transmission rate required for the communication path, compared with the case where image information representing the images of coverage other than a dynamic region is transmitted to the image processing equipment.

It is still another object of the present invention to effectively utilize the result of an individual dynamic image processing for video monitoring irrespective of the number of cameras, compared with a case where the dynamic image processing is performed on all the image information independent from inclusion of the dynamic region.

It is still another object of the present invention to image an object positioned inside a dynamic region with high probability so long as the object displaces to coverages of other cameras even when the dynamic region of any image information received through a communication path is not detected due to failure on the communication path, or insufficiency and a drop in transmission quality.

It is still another object of the present invention to acquire with high probability image information on which a predetermined image processing is to be performed, or image information on which any image processing is to be performed with an image, when no dynamic region is detected from image information representing the image of a coverage assigned from outside.

It is still another object of the present invention to simplify a construction and improve a response in comparison with a case where a dynamic region is detected according to a processing other than interframe coding.

It is still another object of the present invention to suppress both traffic on a communication path used for transferring image information and a transfer delay of the image information including individual dynamic regions to small values even when the amount of the image information including in parallel any dynamic regions is large.

It is still another object of the present invention to efficiently transmit, to an image processing equipment, a timing a dynamic image processing is performed, and image information to be an object of the dynamic image processing, compared with a case where the discrimination result of all the image information is transmitted to the image processing equipment, irrespective of the inclusion of the dynamic region.

It is still another object of the present invention to suppress traffic on a communication path formed to an image processing equipment and transmit with efficiency and high probability image information to be used for pictorial supervisory by executing a dynamic image processing.

It is still another object of the present invention to improve a margin of a transmission band of a communication path formed to an image processing equipment.

It is still another object of the present invention to effectively utilize a transmission band of a communication path formed to an image processing equipment in order to transmit image information on which a dynamic image processing is to be performed by the image processing equipment, and to improve accuracy of video monitoring.

It is still another object of the present invention to shorten a transmission delay time of image information including a dynamic region to be effectively applied to video monitoring, and to highly maintain real time property of video monitoring.

It is still another object of the present invention to secure flexibility of video monitoring and improve added values and reliability.

It is still another object of the present invention to limit with high reliability the increase of traffic on a communication path formed to an image processing equipment.

It is still another object of the present invention to achieve flexible adaptation to various forms of video monitoring.

It is still another object of the present invention to simplify a construction and reduce a load.

It is still another object of the present invention to simplify a construction of video broadcasting equipment connected through a communication path.

It is still another object of the present invention to optimize a load and simplify a construction.

It is still another object of the present invention to improve video monitoring in reliability and probability.

It is still another object of the present invention to limit with high precision the increase of traffic on a communication path formed to a transmitting party of image information including a dynamic region.

It is still another object of the present invention to achieve flexible adaptation to requirements for maintenance and operation of a video monitoring system which realizes video monitoring.

It is still another object of the present invention to flexibly set all or a part of resolution, compression rate, and transmission rate of image information to be given through the communication path in response to requirements for maintenance and operation of a video monitoring system that accomplishes video monitoring.

It is still another object of the present invention to improve performance and reliability economically and flexibly in a video monitoring system where the invention is applied, irrespective of forms of a dynamic image processing executed in practice.

The objects described above can be accomplished by a video broadcasting equipment which discriminates a dynamic region of image information individually representing an image of a coverage of a camera, and transmit the image information and the discrimination result of the dynamic region to an image processing equipment through a communication path.

In the video broadcasting equipment, the image information on which the dynamic image processing is to be performed is specified according to a result of processing of discriminating the dynamic region. The discrimination processing is generally simpler and its throughput is drastically smaller compared to the dynamic image processing. In addition, the discrimination result is notified to the image processing equipment with high probability as an identifier of the image information and a timing where the dynamic image processing is to be performed.

The objects described above can be accomplished by a video broadcasting equipment where image information given from the camera is subjected to interframe coding, and the dynamic region is discriminated according to a difference between a prescribed threshold value and both or either of the information content of a train of the resulting codes or/and the word length of the code constituting the code train.

In the video broadcasting equipment described above, partial image information including the dynamic region suitable for an object of the dynamic image processing is transmitted to the image processing equipment. Therefore, traffic on the communication path formed to the image processing equipment and a transmission rate required for the communication path can be suppressed to lower values than when the image information representing the images of the regions having no dynamic region is transmitted to the image processing equipment.

The objects described above can be accomplished by a video broadcasting equipment characterized in that the image information including the dynamic region is subjected to interframe coding at a higher compression rate than the image information including no dynamic region, and the train of the resulting codes is transmitted together with the discrimination result of the dynamic region to the image processing equipment.

In the video broadcasting equipment described above, discrimination of the dynamic region can be easily accomplished by referring to the train of the codes obtained as a result of interframe coding as described above.

The objects described above can be accomplished by a video broadcasting equipment characterized in that a combination of identifiers of the image information whose dynamic region is discriminated, is transmitted to the image processing equipment as a discrimination result of the dynamic region.

In the video broadcasting equipment, the image information including the dynamic region among the image information given from the cameras is transmitted as a train of codes having smaller information content than the image information including no dynamic region.

The objects described above can be accomplished by a video broadcasting equipment which transmits only image information including the dynamic region to the image processing equipment.

In the video broadcasting equipment, the information transmitted together with the image information to the image processing equipment is limited to a combination of the identifiers of the image information including any dynamic regions.

The objects described above can be accomplished by a video broadcasting equipment which transmits the image information, obtained by superimposing image information with the individual discrimination result of the image information, to the image processing equipment.

In the video broadcasting equipment above, it is possible to prevent useless transmission of image information including no dynamic region and unsuitable for an object of the dynamic image processing, to the image processing equipment.

The objects described above can be accomplished by a video broadcasting equipment which transmits image information including the dynamic region at higher resolution than image information including no dynamic regions, to the image processing equipment.

In the video broadcasting equipment described above, the discrimination result of the dynamic region is transmitted to the image processing equipment within an occupied band of the image information.

The objects described above can be accomplished by a video broadcasting equipment which transmits image information including the dynamic region at a higher transmission rate than image information including no dynamic region to the image processing equipment.

In the video broadcasting equipment described above, image information including any dynamic region and subjected to the dynamic image processing, among the image information individually representing the images of the coverages of cameras, is given with high resolution to the image processing equipment.

The objects described above can be accomplished by a video broadcasting equipment characterized in that a transmission rate of a communication path used for transferring image information including dynamic regions is set to a higher value than that of a communication path used for transferring image information including no dynamic regions.

In the video broadcasting equipment described above, the image information including any dynamic region and subjected to the dynamic image processing is transmitted at a high speed to the image processing equipment.

The objects described above can be accomplished by a video broadcasting equipment characterized in that partial image information including dynamic regions is extracted and transmitted to image processing equipment, together with a discrimination result of the dynamic regions.

In the video broadcasting equipment described above, the image information that includes any dynamic region and is to be subjected to the dynamic image processing is transmitted to the image processing equipment at a high speed.

The objects described above can be accomplished by a video broadcasting equipment characterized in that image information including dynamic regions is transmitted to image processing equipment at a higher compression rate than image information including no dynamic regions.

In the video broadcasting equipment described above, the image information that includes any dynamic regions and is to be subjected to the dynamic image processing is transmitted to the image processing equipment at a high speed in a small transmission band.

The objects described above can be accomplished by a video broadcasting equipment characterized in that image information which is assigned through a communication path is appropriately transmitted to image processing equipment.

In the video broadcasting equipment described above, the image information to be transmitted to the image processing equipment is flexibly selected in association with the image processing equipment or any equipment connected through the communication path.

The objects described above can be accomplished by a video broadcasting equipment characterized in that an identifier of a camera which images adjacent coverage(s) is given in advance to each of coverages of cameras, and image information given from the cameras designated by the individual identifiers that correspond to the coverages of the cameras designated by the image processing equipment is transmitted to the image processing equipment.

In the video broadcasting equipment described above, when the image processing equipment fails to detect a dynamic region during the dynamic image processing due to a failure or a drop in transmission quality on the communication path formed to the image processing equipment, image information to be transmitted to the image processing equipment in place of the image information as the object of the dynamic image processing is limited to the image information given from the cameras whose coverages substantially correspond to the adjacent coverages.

The objects described above can be accomplished by a video broadcasting equipment where a notice of being assigned is given to a specific camera assigned through a communication path and image information given from the specific camera is transmitted to image processing equipment.

In the video broadcasting equipment described above, even when the cameras do not steadily output image information, desired image information can be transmitted to the image processing equipment by flexibly adapting to the conditions of the communication path formed to the image processing equipment or appropriately interlinking with the image processing equipment.

The objects described above can be accomplished by an image processing equipment which receives image information given through a communication path and representing the images of coverages of individual cameras, and a discrimination result of as to whether or not the image information includes dynamic region, and selects image information whose discrimination result is true among the received image information and performs dynamic image processing on the information.

In the image processing equipment described above, the dynamic image processing is applied to only the image information including any dynamic region among the image information individually representing the images of the coverages of the cameras.

The objects described above can be accomplished by an image processing equipment which discriminates a dynamic region of selected image information.

In the image processing equipment described above, even when the dynamic region of any image information received through the communication path is not detected due to a failure on the communication path, and insufficiency and a drop in transmission quality, the image of the object positioned in the dynamic region can be imaged with high probability so long as the object displaces to the coverages of other cameras.

The objects described above can be accomplished by an image processing equipment which performs all or a part of detection of a size, a shape, and movement pattern of an object positioned in each of the dynamic region; tracing of the object; detection of a change in image structure; and detection of the object disappearing from the dynamic region.

In the image processing equipment described above, the dynamic region is discriminated according to accuracy of the dynamic image processing to be performed on the image information. Therefore, lower discrimination accuracy is allowable compared with similar discrimination performed in a video broadcasting equipment connected through a communication path.

The objects described above can be accomplished by an image processing equipment where both or either of a speed and a moving direction of an object positioned in each of the discriminated individual dynamic regions is determined.

In the image processing equipment described above, the dynamic image processing performed on the image information including any dynamic region is collectively executed by the image processing equipment according to the present invention.

The objects described above can be accomplished by an image processing equipment characterized in that when a dynamic region of any image information selected cannot be discriminated, a download request for a substitute image information of this image information is transmitted to a video broadcasting equipment capable of downloading the substitute information through the communication path.

In the image processing equipment described above, the speed and the moving direction can be determined according to accuracy of the dynamic image processing to be performed on the image information including the dynamic region.

The objects described above can be accomplished by an image processing equipment which transmits specific image information other than image information having no discriminated dynamic region, or an identifier representing any camera which outputs the specific image information as a download request of substitute image information.

In the image processing equipment described above, when any failure occurs on a communication path formed to a transmitting party of the image information including the dynamic region and transmission quality of the communication path drops or is not sufficient, an object positioned in the dynamic region can be detected with high probability so long as it displaces to the coverages of other cameras.

The objects described above can be accomplished by an image processing equipment characterized in that an identifier of a camera which images adjacent coverages are given in advance to each of the coverages of the cameras, and a download of substitute image information imaged by a camera having an identifier corresponding to the coverages to be given an image represented by image information having no dynamic regions, is requested.

In the image processing equipment described above, when an image processing section cannot detect a dynamic region during the dynamic image processing due to a failure on the communication path formed to the transmitting party of the image information including the dynamic region and a drop in transmission quality, the image information where the dynamic image processing is to be performed in place of the image information as the object of the dynamic image processing is limited to the image information given from the cameras whose coverages substantially correspond to the adjacent coverages.

The objects described above can be accomplished by an image processing equipment characterized in that a download of image information is requested to a camera assigned through a communication path under a man-machine interface.

In the image processing equipment described above, the dynamic image processing is appropriately executed not only on image information, that is confirmed as including the dynamic region by the above video broadcasting equipment and is given through the communication path, but also on desired image information directed by an operator during the video monitoring process.

The objects described above can be accomplished by an image processing equipment which requests a download of image information to be performed at all or a part of resolution, compression rate, and transmission rate set under a man-machine interface.

In the image processing equipment described above, it is possible to flexibly set all or a part of resolution, compression rate, and transmission rate of the image information to be given through the communication path in accordance with requirements for maintenance and operation of a video monitoring system that realizes video monitoring.

The objects described above can be accomplished by a camera including an imaging section for imaging image information representing an image of a coverage, wherein a relative position of the coverage to the coverages of other cameras is given in advance and the image information generated by the imaging section is outputted when the relative position is adjacent coverages of the coverage assigned from outside.

In the camera described above, the image information representing the image of the coverage is automatically outputted when the coverage corresponds to the adjacent coverages of the coverage assigned from outside.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a block diagram showing the principle of video broadcasting equipment according to the present invention;

FIG. 2 is a block diagram showing the principle of image processing equipment according to the present invention;

FIG. 3 is a block diagram showing the principle of a camera according to the present invention;

FIG. 4 is a diagram showing the first to fifth embodiments of the present invention;

FIG. 5 is a diagram useful for explaining operations of the first to fourth embodiments of the present invention;

FIG. 6 is a diagram useful for explaining of the fifth embodiment of the present invention;

FIG. 7 shows the construction of a coverage database; and

FIG. 8 shows a structural example of a video monitoring system.

### DESCRIPTION OF THE PREFERRED EMBODIMENTS

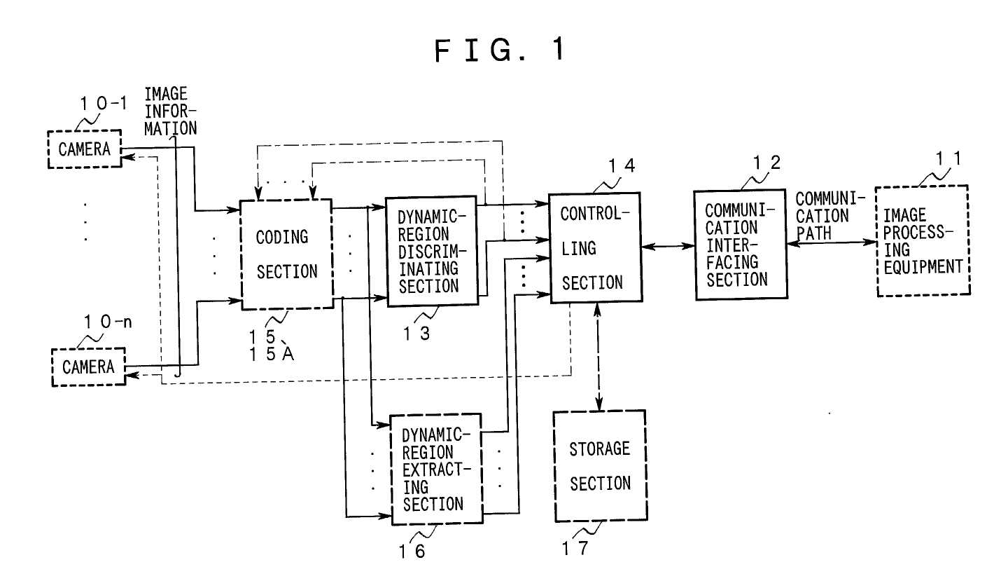

Referring initially to FIG. 1, the principle of video broadcasting equipment according to the present invention will be explained.

FIG. 1 is a block diagram showing the principle of the video broadcasting equipment according to the present invention.

The video broadcasting equipment shown in FIG. 1 includes a communication interfacing section 12 connected to an image processing equipment 11 through a communication path, a dynamic-region discriminating section 13, a controlling section 14, coding sections 15 and 15A connected to cameras 10-1 to 10-n, a dynamic-region extracting section 16 and a storage section 17.

The principle of the first video broadcasting equipment according to the present invention is as follows.

The communication interfacing section 12 forms the communication path to the image processing equipment 11 that executes dynamic image processing on image information given by a single or a plurality of cameras 10-1 to 10-n and individually representing the image of coverage of each camera. The dynamic-region discriminating section 13 discriminates the dynamic region of the image information individually representing the images of the coverages of the cameras 10-1 to 10-n. The controlling section 14 transmits the image information and the discrimination result of the dynamic region to the image processing equipment 11 through the communication path formed by the communication interfacing section 12.

In the video broadcasting equipment described above, the image information where the dynamic image processing is to be executed among the image information individually representing the images of the coverages of the cameras 10-1 to 10-n is specified according to a result of processing of discriminating the dynamic region. The discrimination processing is generally simpler and has drastically smaller throughput compared with the dynamic image processing. The result is notified with high probability to the image processing equipment 11 as an identifier of the image information and a timing where the dynamic image processing is to be performed.

Therefore, the image processing equipment 11 can execute the dynamic image processing on only image information suitable for the object of the dynamic image processing among the image information described above. In comparison with the prior art example where such a dynamic image processing is executed in the individual video broadcasting equipment, or the processing is executed uselessly on all the image information in the image processing equipment 11, the image processing equipment 11 of this embodiment can easily secure performance required for video monitoring, simplify the construction, and reduce the cost.

The principle of the second video broadcasting equipment according to the present invention is as follows.

The dynamic-region extracting section 16 extracts partial image information including the individual dynamic regions discriminated by the dynamic-region discriminating section 13 among the regions of the image information given by a single or a plurality of cameras 10-1 to 10-n. The controlling section 14 transmits to the image processing equipment I I the partial image information together with the discrimination result obtained by the dynamic-region discriminating section 13.

In the video broadcasting equipment described above, the partial image information including the dynamic regions suitable for the object of the dynamic image processing is transmitted to the image processing equipment. Therefore, the traffic on the communication path formed to the image processing equipment and the transmission rate required for the communication path can be kept at lower levels than when the image information representing the images of the regions not corresponding to such a dynamic region are transmitted to the image processing equipment.

The principle of the third video broadcasting equipment according to the present invention is as follows.

In the video broadcasting equipment according to the present invention, the coding section 15 interframe codes image information given by a single or a plurality of cameras 10-1 to 10-n as a part of MPEG video coding and generates a train of codes representing the image information. The dynamic-region discriminating section 13 discriminates the dynamic region according to a difference between a prescribed threshold value and both or either of the information content of the train of the codes and/or the word length of the codes constituting the train of the code. The controlling section 14 transmits the train of the codes generated by the coding section 15 as the image information together with the discrimination result of the dynamic-region discriminating section 13 to the image processing equipment 11.

In the video broadcasting equipment described above, the dynamic region can be easily discriminated by referring to the train of the codes obtained as a result of interframe coding.

Therefore, it is possible to simplify the construction and improve response in comparison with the case where the dynamic region is discriminated according to a processing different from interframe coding.

The principle of the fourth video broadcasting equipment according to the present invention is as follows.

In the video broadcasting equipment according to the present invention, the coding section 15A performs interframe coding of image information including a dynamic region, that is discriminated by dynamic-region discriminating section 13 at a higher compression rate than the image information including no dynamic region among the image information given by a single or a plurality of cameras 10-1 to 10-n, and generates a train of codes representing these image information. The controlling section 14 transmits, to the image processing equipment 11, the train of the codes generated by the coding section 15A as the image information together with the discrimination result from the dynamic-region discriminating section 13.

In the video broadcasting equipment described above, the image information including the dynamic region is transmitted as the train of the codes having a smaller information content than the image information including no dynamic region through the communication path.

Therefore, even when the amount of image information including in parallel any dynamic regions is large, the traffic on the communication path and the transmission delay of the image information including the individual dynamic regions can be suppressed to small values.

The principle of the fifth video broadcasting equipment according to the present invention is as follows.

In the fifth video broadcasting equipment according to the present invention, the controlling section 14 transmits a combinations of identifiers of the image information whose dynamic regions are discriminated by the dynamic-region discriminating section 13, to the image processing equipment 1I1 as the discrimination result, together with the image information.

In the video broadcasting equipment described above, the information to be transmitted to the image processing equipment 1I with the image information is limited to the combination of the identifiers including any dynamic regions.

Therefore, the timing the dynamic image processing is performed and the image information to be the object of the dynamic image processing are transmitted more efficiently to the image processing equipment 1I than when the discrimination results of all the image information are transmitted to the image processing equipment 1I1 irrespective of inclusion of a dynamic region.

The principle of the sixth video broadcasting equipment according to the present invention is as follows.

In the sixth video broadcasting equipment according to the present invention, the controlling section 14 transmits only the image information including the dynamic regions which are discriminated by dynamic-region discriminating section 13, to image processing equipment 11.

This video broadcasting equipment can avoid problems that the image information including no dynamic regions and not suitable for the object of the dynamic image processing is transmitted in vain to the image processing equipment 11.

Consequently, the traffic on the communication path formed to the image processing equipment 1I1 can be kept at a low level and the image information used for video monitoring after the dynamic image processing performed can be transmitted with efficiency and high probability.

The principle of the seventh video broadcasting equipment according to the present invention is as follows.

In the seventh video broadcasting equipment according to the present invention, the controlling section 14 transmits, to image processing equipment 11, the superimposed image information of the individual image information superimposed with the discrimination result of the individual image information by dynamic-region discriminating section 13.

In the video broadcasting equipment described above, the individual discrimination result obtained by the dynamic-region discriminating section 13 is transmitted to the image processing equipment 11 inside the occupied band of the image information.

Therefore, so long as the image can be discriminated efficiently and reliably in the image processing equipment 11, the margin of the transmission band of the communication path formed to the image processing equipment 11 can be improved.

The principle of the eighth video broadcasting equipment according to the present invention is as follows.

In the eighth video broadcasting equipment according to the present invention, the controlling section 14 transmits, to image processing equipment 11, image information including the dynamic regions discriminated by dynamic-region discriminating section 13 at higher resolution than image information including no dynamic regions among the image information individually representing the images of the coverage(s) of a single or a plurality of cameras 10-1 to 10-n.

In the video broadcasting equipment described above, the image information that includes any dynamic regions and is to be subjected to the dynamic image processing is given with high resolution to the image processing equipment 11.

Therefore, the transmission band of the communication path formed to the image processing equipment 11 can be utilized effectively for transmitting the image information to be subjected to the dynamic image processing by the image processing equipment 11 and for improving accuracy of video monitoring.

The principle of the ninth video broadcasting equipment according to the present invention is as follows.

In the ninth video broadcasting equipment according to the present invention, the controlling section 14 transmits at a higher transmission rate the image information including the dynamic regions discriminated by dynamic-region discriminating section 13 than the image information including no dynamic regions, to the image processing equipment 11.

In the video broadcasting equipment described above, the image information that includes any dynamic regions and is to be subjected to the dynamic image processing is transmitted at a high speed to the image processing equipment 11.

Therefore, it is possible to shorten the transmission delay time of the image information including the dynamic regions to be effectively applied to video monitoring and maintain the real time property of video monitoring at a high level.

The principle of the tenth video broadcasting equipment according to the present invention is as follows.

In the tenth video broadcasting equipment according to the present invention, the communication interfacing section 12 sets a transmission rate of a communication path used for transferring image information including the dynamic regions discriminated by dynamic-region discriminating section 13 to a higher value than that of a communication path used for transferring the image information including no dynamic regions among the image information individually representing the images of the coverages of a single or a plurality of cameras 10-1 to 10-n.

In the video broadcasting equipment described above, the image information that includes any dynamic regions and is to be subjected to the dynamic image processing is transmitted at a high transmission rate to the image processing equipment 11.

Therefore, the transmission delay time of the image information including the dynamic regions to be effectively applied to video monitoring can be shortened and the real time property of image monitoring can be kept at a high level.

The principle of the eleventh video broadcasting equipment according to the present invention is as follows.

In the eleventh video broadcasting equipment according to the present invention, the controlling section 14 transmits, to image processing equipment 11, image information including the dynamic regions discriminated by the dynamic-region discriminating section 13 at a higher compression rate than the image information including no dynamic regions among the image information individually representing the images of coverages of a single or a plurality of cameras 10-1 to 10-n.

In the video broadcasting equipment described above, the image information that includes any dynamic regions and is to be subjected to the dynamic image processing is transmitted to the image processing equipment 11 at a high speed in a small transmission band.

Therefore, so long as the compression rate has an appropriate value for securing transmission quality required for video monitoring, the propagation delay time of the image information including the dynamic regions can be shortened and the real time property of video monitoring can be kept at a high level.

The principle of the twelfth video broadcasting equipment according to the present invention is as follows.

In the twelfth video broadcasting equipment according to the present invention, the controlling section 14 transmits, to image processing equipment 11, the image information which is assigned through a communication path formed by communicating interfacing section 12 among the image information individually representing the images of coverages of a single or a plurality of cameras 10-1 to 10-n.

In the video broadcasting equipment described above, the image information to be transmitted to the image processing equipment 11 is flexibly selected in association with the image processing equipment 11 or any equipment connected through the communication path.

Therefore, it is possible to secure flexibility of video monitoring and improve added values and reliability.

The principle of the thirteenth video broadcasting equipment according to the present invention is as follows.

In the thirteenth video broadcasting equipment according to the present invention, an identifier of a camera which images adjacent coverage(s) of a single or a plurality of cameras 10-1 to 10-n is registered in advance in the storage section 17. The controlling section 14 specifies a camera, which has an identifier registered in the storage section 17, corresponding to a coverage of a camera designated by the image processing equipment 11, and transmits image information given from the specified camera to the image processing equipment 11.

In the video broadcasting equipment described above, when the image processing equipment 1I1 fails to detect the dynamic regions during its process of dynamic image processing due to a failure on the communication path formed to the image processing equipment 11 or a drop in transmission quality, the image information to be transmitted to the image processing equipment 11 in place of the image information as the object of the dynamic image processing is limited to the image information given from the camera whose coverage substantially corresponds to the adjacent coverages.

Therefore, an increase of the traffic on the communication path is limited so as to adapt to the combination of the identifiers stored in advance in the storage section 17.

The principle of the fourteenth video broadcasting equipment according to the present invention is as follows.

In the fourteenth video broadcasting equipment according to the present invention, the controlling section 14 gives a notification of being assigned to a specific camera which is assigned through a communication path among a single or a plurality of cameras 10-1 to 10-n, and transmits the image information given from the specific camera to the image processing equipment 11.

Therefore, even when the cameras 10-1 to 10-n do not steadily output the image information, the video broadcasting equipment can transmit the desired image information to the image processing equipment 11 while flexibly coping with the condition of the communication path formed to the image processing equipment 11 or in association with the image processing equipment 11.

Therefore, the video broadcasting equipment can flexibly adapt to diversified forms of video monitoring.

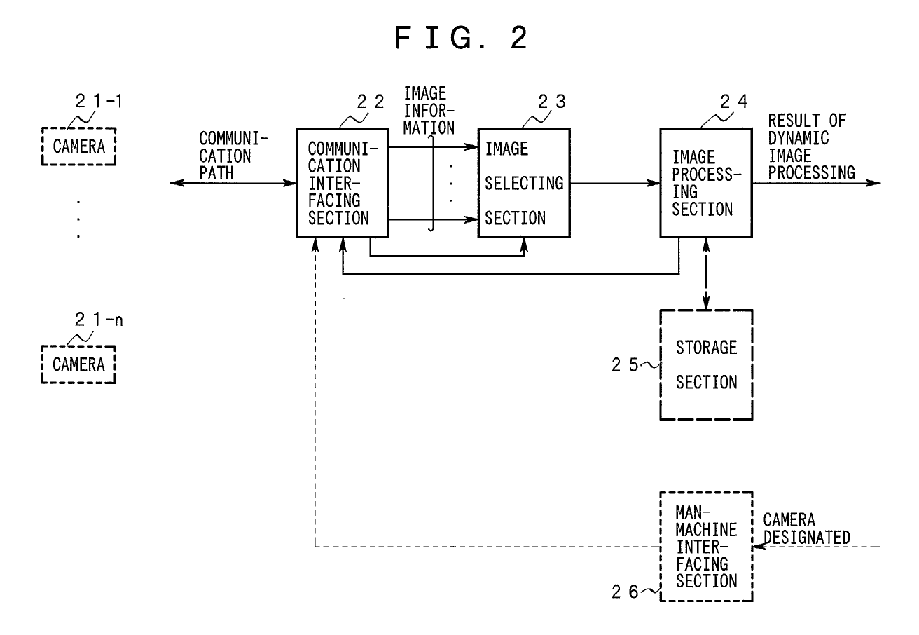

FIG. 2 is a block diagram showing the principle of image processing equipment according to the present invention.

The image processing equipment shown in FIG. 2 includes a communication interfacing section 22 cooperating with camera 21-1 to 21-n, an image selecting section 23, an image processing section 24, a storage section 25 and a man-machine interfacing section 26.

The principle of the first image processing equipment according to the present invention is as follows.

In the first image processing equipment according to the present invention, the communication interfacing section 22 receives the image information given through a communication path and representing individually the coverages of a single or a plurality of cameras 21-1 to 21-n and a discrimination result of as to whether or not the image information includes the dynamic region. The image selecting section 23 selects the image information whose discrimination result is true, from the received image information. The image processing section 24 executes the dynamic image processing on the selected image information.

In the image processing equipment described above, the dynamic image processing is performed on only the image information that includes any dynamic regions among the image information individually representing the images of the coverages of the cameras 21-1 to 21-n.

Therefore, the result of the individual dynamic image processing can be used more effectively for video monitoring irrespective of the number n of the cameras 21-1 to 21-n so long as the amount of the image information that can include in parallel the dynamic regions is not excessively large, in comparison with the case where the dynamic image processing is performed all the image information independent from inclusion of the dynamic region.

The principle of the second image processing equipment according to the present invention is as follows.

In the second image processing equipment according to the present invention, when a dynamic region of image information selected by the image selecting section 23 cannot be discriminated, the image processing section 24 transmits download request of substitute image information to the video broadcasting equipment capable of downloading the substitute image information through the communication interfacing section 22 and the communication path.

In the image processing equipment described above, even when the dynamic region of any image information received through the communication path cannot be detected due to a failure on the communication path, or insufficiency and a drop in transmission quality, the image of the object positioned in the dynamic region can be imaged with high probability so long as the object displaces to the coverages of other cameras.

The principle of the third image processing equipment according to the present invention is as follows.

In the third image processing equipment according to the present invention, the image processing section 24 discriminates the dynamic region of the image information selected by the image selecting section 23.

Since such a dynamic region is discriminated according to accuracy of the dynamic image processing to be performed on the image information described above, lower discrimination accuracy is allowable compared with similar discrimination executed by the video broadcasting equipment connected through the communication path.

Therefore, the construction can be simplified and the load can be mitigated.

The principle of the fourth image processing equipment according to the present invention is as follows.

In the fourth image processing equipment according to the present invention, the image processing section 24 executes all or a part of detection of a size, shape, and movement pattern of an object positioned in each of the discriminated dynamic regions, tracing of the object, detection of a change in image structure, and detection of an object disappearing from the dynamic regions.

In the image processing equipment described above, the dynamic image processing of the image information including any dynamic region can be collectively executed by the image processing equipment according to the present invention.

Therefore, the construction of the video broadcasting equipment connected through the communication path can be simplified.

The principle of the fifth image processing equipment according to the present invention is as follows.

In the fifth image processing equipment according to the present invention, the image processing section 24 determines both or either of the speed and/or the moving direction of the object positioned in each of the discriminated dynamic region.

The speed and moving direction are determined according to accuracy of the dynamic image processing to be performed on the image information including the dynamic region.

Therefore, it becomes possible to optimize the load and simplify the construction.

The principle of the sixth image processing equipment according to the present invention is as follows.

In the sixth image processing equipment according to the present invention, the image processing section 24 transmits specific image information other than the image information having no discriminated dynamic region, or an identifier representing any of the cameras outputting the specific image information as a download request of substitute image information.

In the image processing equipment described above, the object positioned in the dynamic region can be detected with high accuracy during the dynamic image processing so long as the object displaces to the coverages of other cameras even when any failure occurs on the communication path formed to the transmitting party of the image information including the dynamic region, and transmission quality of the communication path drops or is not sufficient.

Therefore, reliability and probability of video monitoring can be improved.

The principle of the seventh image processing equipment according to the present invention is as follows.

In the seventh image processing equipment according to the present invention, the identifiers of cameras which images adjacent coverage(s) of a single or a plurality of cameras 21-1 to 21-n are registered in advance in the storage section 25. The image processing section 24 specifies a coverage where an image including no dynamic region is imaged, and requests a download of substitute image information acquired by a camera having an identifier of the specified coverage registered in the storage section 25, through the communication interfacing section 22 and the communication path.

In the image processing equipment described above, when the image processing section 24 fails to detect a dynamic region in the process of the dynamic image processing due to a failure on the communication path formed to the transmitting party of the image information including the dynamic region or due to a drop in transmission quality, image information where the dynamic image processing is performed, in place of the image information as the object of the dynamic image processing, is limited to image information given from a camera whose coverage corresponds substantially to the adjacent coverages.

Therefore, an increase of the traffic on the communication path is limited so as to adapt to the combination of the identifiers stored in advance in the storage section 25.

The principle of the eighth image processing equipment according to the present invention is as follows.

In the eighth image processing equipment according to the present invention, the man-machine interfacing section 26 specifies a camera designated under man-machine interface among a single or a plurality of cameras 21-1 to 21-n, and requests a download of the image information to the camera which is assigned through the communication interfacing section 22 and the communication path.

In the image processing equipment described above, the dynamic image processing can be appropriately performed not only on the image information that is confirmed to include the dynamic region by the video broadcasting equipment and is given through the communication path, but also on the desired image information directed by an operator during the video monitoring process.

Therefore, the image processing equipment can flexibly cope with requirements for maintenance and operation of the video monitoring system accomplishing video monitoring.

The principle of the ninth image processing equipment according to the present invention is as follows.

In the ninth image processing equipment according to the present invention, the man-machine interfacing section 26 requests a download of the image information to be performed at all or a part of resolution, compression rate, and transmission rate set under the man-machine interface.

In the image processing equipment described above, all or a part of resolution, compression rate, and transmission rate of the image information to be given through the communication path is flexibly set in accordance with requirements for maintenance and operation of the video monitoring system accomplishing video monitoring.

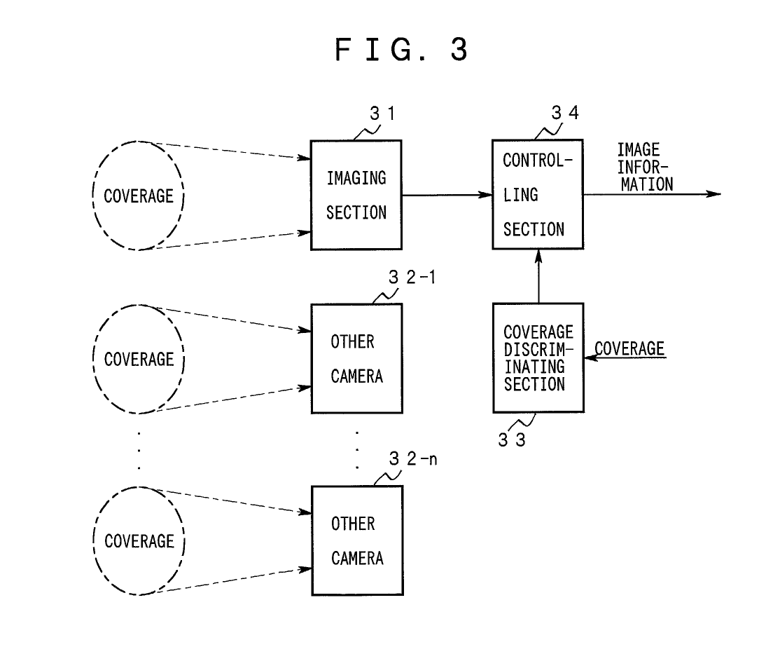

FIG. 3 is a block diagram showing the principle of the camera according to the present invention.

The camera shown in FIG. 3 includes an imaging section 31, other cameras 32-1 to 32-n, a coverage judging section 33, and a controlling section 34.

The principle of the camera according to the present invention is as follows.

In the camera according to the present invention, the imaging section 31 images an image of a coverage and generates image information representing the image. A relative position of the coverage to the coverages of other cameras 32-1 to 32-n is given in advance to the discriminating section 33. The coverage judging section 33 discriminates whether or not the relative position corresponds to the adjacent coverages of a coverage designated from outside. When a discrimination result from the coverage judging section 33 is true, the controlling section 34 outputs the image information generated by the imaging section 31.

In the camera described above, the image information representing the image of the coverage imaged by the imaging section 31 is automatically outputted when the coverage corresponds to the adjacent coverages of the coverage designated from outside.

Therefore, it is possible to obtain with high probability image information where a predetermined image processing is to be performed, or image information that is to be subjected to any image processing with the image, under the initiative of the camera according to the present invention, when the dynamic region is not detected from the image information representing the image of the coverage designated from outside.

Hereinafter, preferred embodiments of the present invention will be explained in detail with reference to the drawings.

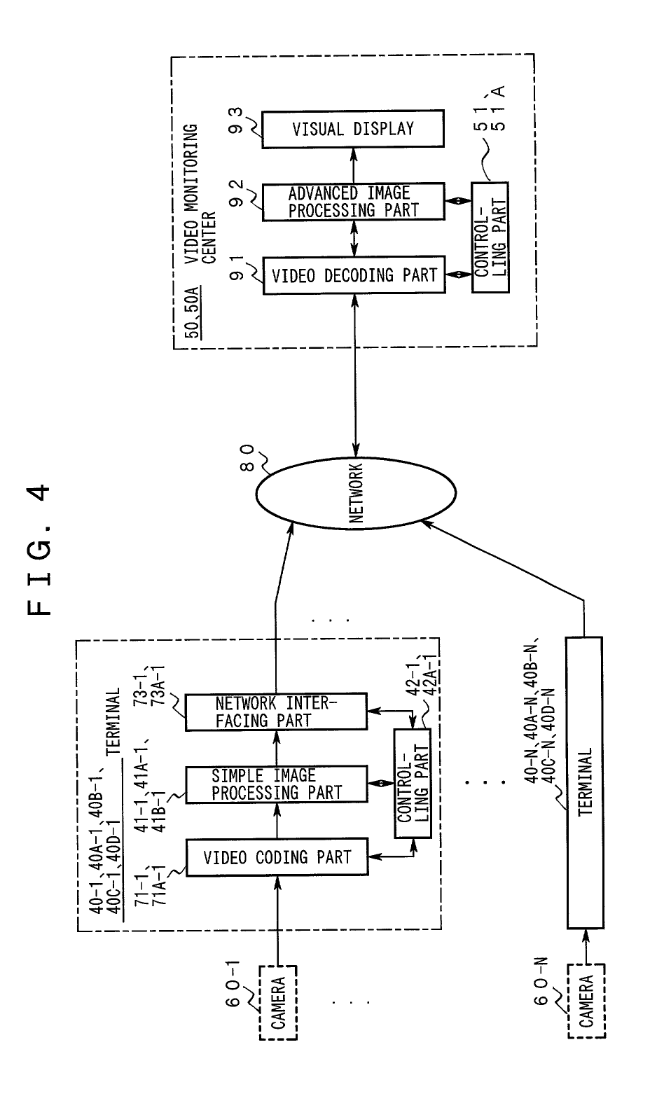

FIG. 4 shows the first to fifth embodiments of the present invention.

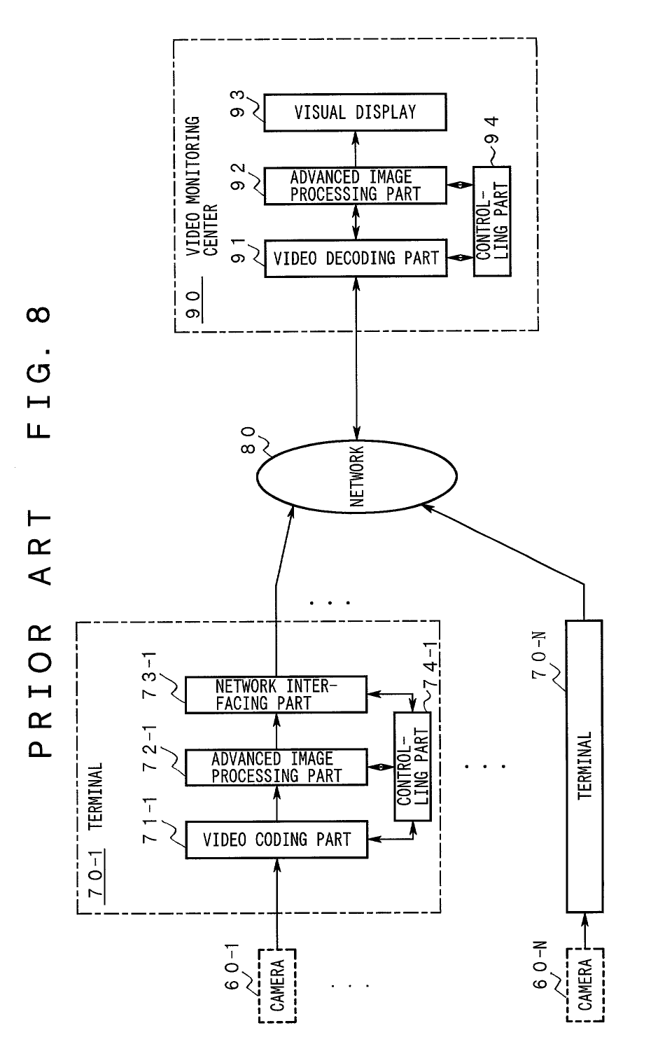

In the drawing, the same reference numeral is used to identify the constituent having the same function and construction as the one shown in FIG. 8, and the explanation of such a constituent is omitted.

The structural feature of this embodiment shown in FIG. 8 is that terminals 40-1 to 40-N are disposed in place of the terminal equipment 70-1 to 70-N and a video monitoring center 50 is disposed in place of the video monitoring center 90.

The structural difference of the terminal equipment 40-1 from the terminal equipment 70-1 shown in FIG. 8 is that a simple image processing part 41-1 is provided in place of the advanced image processing part 72-1 and a controlling part 42-1 is provided in place of the controlling part 74-1.

The construction of the terminal equipment 40-2 to 40-N is the same as the construction of the terminal equipment 40-1. Therefore, suffixes “2” to “N” are allotted to the corresponding constituents, and explanation and illustration of such constituents are hereby omitted.

The structural feature of the video monitoring center 50 shown in FIG. 8 is that a controlling part 51 is provided in place of the controlling part 94.

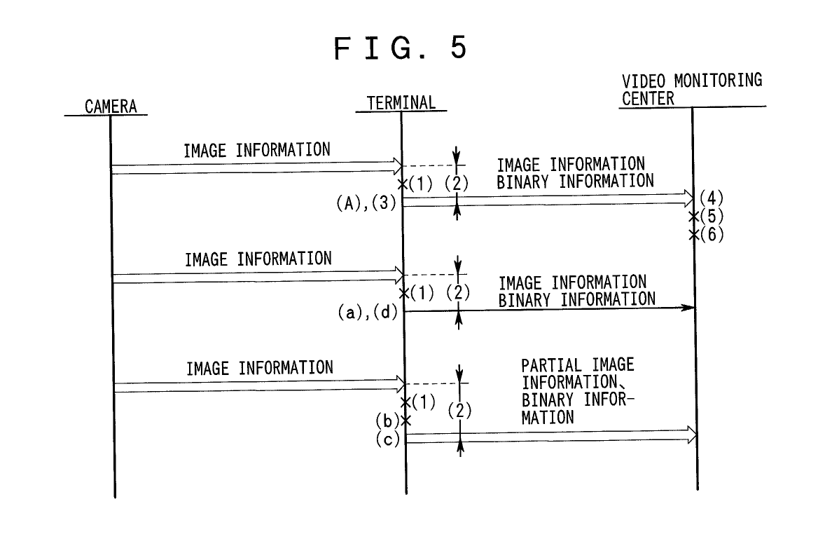

FIG. 5 is a diagram useful for explaining the operations of the first to fourth embodiments of the present invention.

Next, the operation of the first embodiment of the present invention will be explained with reference to FIGS. 4 and 5.

Incidentally, the suffix “C”, that is applicable to any of the suffixes “1” to “N”, is put to 30 the matter common to the terminal equipment 40-1 to 40-N in place of these suffixes “1” to “N”.

In the terminal equipment 40-C, the video coding part 71-C codes the image signal given from the camera 60-C on the basis of the MPEG system in the same way as in the prior art example, and generates the image information representing this image signal in the digital region (FIG. 5(1)).

When the instruction to execute the simple image processing is given from the controlling part 42-C, the simple image processing part 41-C executes in parallel the following processing:

a processing for giving serially the image information generated by the video coding part 71-C to a network interfacing part 73-1;

a processing for judging whether or not both, or either one, of the information content given per unit time as the image information and the word length of the code exceed a predetermined upper limit value (FIG. 5(2)).

The network interfacing part 73 multiplexes both of the image information given through the simple image processing part 41-C and the binary information representing the judgment result, and serially transmits the multiplex signal so obtained to the video monitoring center 50 through the path formed to the video monitoring center 50 through the network 80 (FIG. 5(3)).

A video decoding part 91 in the video monitoring center 50 applies a de-multiplexing processing, that is opposite to the multiplexing processing executed by the network interfacing part 73-C provided to the terminal equipment 40-C, to the individual signals received in parallel through the path formed to the terminal equipment 40-1 to 40-N, thereby acquiring the binary information and the image information (FIG. 5(4)).

Furthermore, the video decoding part 91 selects the image information for which the corresponding binary information represents the discrimination result of “true” among the image information (FIG. 5(5)). (When the image information designated under the man-machine interface executed in parallel by the controlling part 51 exists, the image information includes such image information.) An advanced image processing part 92 gives the image information to a visual display 93 in accordance with the instruction from the controlling part 51 without applying any image processing to the decoded image information, or gives the image information generated by applying the aforementioned dynamic image processing to the image information, to the visual display 93 (FIG. 5(6)).

Incidentally, the detail of the dynamic image processing is fundamentally the same as the dynamic image processing executed in the prior art example, and its explanation is hereby omitted.

On the display screen of the visual display 93, the image information representing the condition of the coverage, into which any object comes in or from which an existing object comes out (displaces) or disappears (hereinafter called merely an “event”), among the coverages individually imaged by the cameras 60-1 to 60-C positioned at remote places through the network 80 is preferentially selected, is subjected to desired dynamic image processing and is displayed.

As described above, this embodiment is provided with the simple image processing part 41 -C having a smaller scale than the advanced image processing part 72-C to constitute the terminal equipment 40-C in place of the advanced image processing part 72-C shown in FIG. 8. In the video monitoring center 50, on the other hand, the image of the coverage in which the event occurs among the coverages of the cameras 60-1 to 60-N is subjected to the necessary dynamic image processing and is reliably displayed.

Therefore, the reduction of the cost and the improvement of reliability can be attained in comparison with the prior art example, and video monitoring can be achieved stably in such a fashion as to flexibly cope with the broad values of the number N of the terminal equipment 40-1 to 40-N.

The simple image processing part 41-C provided to the terminal equipment 40-C in this embodiment judges whether or not both, or either one, of the information content of the code generated by the video coding part 71-C and given as the image information and the word length of the code exceeds the predetermined upper limit value, and thus discriminates whether or not the event occurs in the coverage of the camera 60-C.

However, the present invention is not limited to such a construction. For example, discrimination as to whether or not a similar event occurs may be accomplished as an “interframe correlation processing” that computes the interframe correlation of the image signals given from the camera 60-C and judges whether or not the result exceeds a threshold value.

In this embodiment, individual paths are formed between the terminal equipment 40-1 to 40-N and the video monitoring center 50 through the network 80.

However, the present invention is not limited to the construction described above. For example, when a message switching system or a store-and-forward switching system is applied to the network 80, the combination comprising the identifier representing the terminal equipment 40-C as the transmitting party with the binary information and the image information described above may be transmitted to the video monitoring center 50 and the coverage to be displayed as the image through the visual display 93 may be identified on the basis of this identifier.

In this embodiment, the binary information representing the identification result and the corresponding image information are merely multiplexed and are transmitted to the video monitoring center 50.

However, the present invention is not limited to such a construction. For example, the combination of the image information and the binary information as the image information superimposed with the binary information corresponding to a part of the image represented by the image information may be transmitted to the video monitoring center 50.

Next, the second embodiment of the present invention will be explained.

The structural feature of the second embodiment is that terminal equipment 40A-1 to 40A-N is provided in place of the terminal equipment 40-1 to 40-N.

The structural feature of the terminal equipment 40A-1 is that a network interfacing part 73A-1 is provided in place of the network interfacing part 73-1.

The construction of the terminal equipment 40A-2 to 40A-N is the same as the construction of the terminal equipment 40A-1. Therefore, suffixes “2” to “N” will be allotted hereinafter to corresponding constituents and explanation and illustration of such constituents will be omitted.

Hereinafter, the operation of the second embodiment of the present invention will be explained with reference to FIGS. 4 to 5.

The feature of this embodiment from the first embodiment resides in the following processing that the network interfacing part 73A-C executes in the terminal equipment 40A-C.

Incidentally, the suffix “C”, that is applicable to any of the suffixes “1” to “N”, will be applied to the matters common to the terminal equipment 40A-1 to 40A-N in place of the suffixes “1” to “N”.

In the terminal equipment 40A-C, the network interfacing part 73A-C accepts the image information given through the simple image processing part 41-C and the binary information representing the result of discrimination performed by this simple image processing part 41-C, and executes the following processing in accordance with the value of the binary information.

(1) When the discrimination result represented by binary information is true:

Both of the image information and the binary information are multiplexed and are serially transmitted to the video monitoring center 50 in the same way as in the first embodiment (FIG. 5(3)).

(2) When the discrimination result represented by binary information is false:

Only the binary information is serially transmitted to the video monitoring center 50 (FIG. 5(a)).

In other words, only the terminal equipment in which the aforementioned event occurs in the corresponding coverage among the terminal equipment 40A-1 to 40A-N transmits the image information to the video monitoring center 50.

According to this embodiment, therefore, the useless image information to which the dynamic image processing is not at all applied in the video monitoring center 50 and which is not displayed on the visual display 93 is not transmitted through the network 80.

In consequence, the average traffic on the network 80 can be reduced, resources can be utilized effectively, and the running cost of the network 80 and the video monitoring center 50 can be reduced.

Next, the third embodiment of the present invention will be explained.

The structural feature of this embodiment is that terminal equipment 40B-1 to 40B-N is provided in place of the terminal equipment 40-1 to 40-N.

Incidentally, the suffix “C”, that is applicable to any of the suffixes “1 ”to “N”, will be allotted to the matter common to the terminal equipment 40B-1 to 40B-N in place of these suffixes “1 ”to “N”.

The structural feature of the terminal equipment 40B-1 is that a simple image processing part 41A-1 is provided in place of the simple image processing part 41-1.

The construction of the terminal equipment 40B-2 to 40B-N is the same as that of the terminal equipment 40B-1. Therefore, suffixes “2” to “N” will be allotted to the corresponding constituents and explanation and illustration of such constituents will be omitted.

Hereinafter, the operation of the third embodiment of the present invention will be explained with reference to FIGS. 4 and 5.

The structural feature of this embodiment resides in the following processing that the simple image processing part 41A-C executes in the terminal equipment 40B-C.

In the terminal equipment 40B-C, the simple image processing part 41A-C makes judgment in the same way as in the first embodiment and executes the following processing according to the discrimination result.

(1) When the discrimination result is true:

i) The simple image processing part 41A-C extracts the partial image information comprising the pixels that give the factors for making the corresponding discrimination result true and the surrounding pixels among the image information given from the video coding part 71 -C (FIG. 5(b)).

ii) The simple image processing part 41A-C gives the discrimination result (binary information) corresponding to the partial image information to the network interfacing part 73-C in place of the image information given from the video coding part 71-C.

(2) When the discrimination result is false:

The simple image processing part 41A-C serially transmits only the discrimination result to the video monitoring center 50 through the network interfacing part 73-C.

When the partial image information and the discrimination result are given from the simple image processing part 41A-C, the network interfacing part 73-C multiplexes them and serially transmits them to the video monitoring center 50 (FIG. 5(c)). When only the discrimination result is given, on the contrary, the network interfacing part 73-C serially transmits only the discrimination result to the video monitoring center 50 (FIG. 5(d)).

In other words, the image information to be transmitted to the video monitoring center 50 by the terminal equipment in which any event occurs in the corresponding coverage among the terminal equipment 40B-1 to 40B-N is limited to the partial image information including the pixels as the cause for the occurrence of the event.

In this embodiment, therefore, the image information that is not compatible to the dynamic image processing performed in the video monitoring center 50 and need not always be displayed is not uselessly transmitted through the network 80.

In comparison with the second embodiment, therefore, the mean traffic of the network 80 can be further reduced, the resources can be utilized much more effectively, and the running cost of the network 80 and the video monitoring center 50 can be further saved.

Next, the fourth embodiment of the present invention will be explained.

The feature of this embodiment from the first embodiment is that terminal equipment 40C-1 to 40C-N is provided in place of the terminal equipment 40-1 to 40-N.

The structural feature of the terminal equipment 40C-1 is that a video coding part 71A-1 is provided in place of the video coding part 71-1 and a simple image processing part 41B-1 is provided in place of the simple image processing part 41-1.

Incidentally, since the construction of the terminal equipment 40C-2 to 40C-N is the same as that of the terminal equipment 40C-1, symbols with the suffixes “2” to “N” will be allotted to the corresponding constituents, and explanation and illustration will be omitted.

Hereinafter, the operation of the fourth embodiment according to the present invention will be explained with reference to FIGS. 4 and 5.

Incidentally, symbol “C”, that is applicable to any of the suffixes “1” to “N”, will be allotted to the matter common to the terminal equipment 40C-1 to 4OC-N in place of the suffixes “1 ” to “N”.

The feature of this embodiment from the first embodiment resides in the following processing procedures that are performed by the video coding part 71A-C and the simple image processing part 41 B-1 in the terminal equipment 40C-C.

In the terminal equipment 40C-C, the simple image processing part 41 B-C discriminates the compression rate of the image signal given from the video coding part 71A-C, executes the discrimination described above irrespective of the compression rate and notifies appropriately the discrimination result to the video coding part 71A-1. It will be assumed hereby for simplicity that the discrimination result is notified through the controlling part 42-C.

During the period in which the discrimination result so notified is true (hereinafter called merely the “specific period”), the video coding part 71A-1 executes coding described already at a greater compression rate than during the period in which the discrimination result is false, and gives the image information generated as a result of coding to the simple image processing part 41 B-C.

The simple image processing part 41 B-C and the network interfacing part 73-C cooperate with each other under control of the controlling part 42-1 in the same way as in the first embodiment, multiplex the image information and the binary information and transmit them to the video monitoring center 50 (FIG. 5(A)).

In other words, the image signal given from the camera in which any event occurs in the photogenic zone among the cameras 60-1 to 60-N is transmitted to the video monitoring center 50 at a higher speed than the image signal given from the camera in which no such event occurs.

According to this embodiment, therefore, the image signal representing any event can be stably downloaded to the video monitoring center while keeping real time property and is offered for the video monitoring operation through the visual display 93 even under the condition where the transmission delay time and the traffic distribution (degree of congestion) fluctuate.

In this embodiment, the code rate achieved by the video coding part 71A-C during the coding process is set to a large value throughout the specific period, and the transmission rate of the image information to be transmitted to the video monitoring center during this specific period can be set to a high level.

However, the present invention is not limited to the construction described above. For example, an equivalent transmission rate may be accomplished as the network interfacing part 73-C executes both, or either one, of the following processing.

A processing that updates a substantial transmission rate of the path formed to the video monitoring center 50 to a higher value for the specific period; and

A processing that forms a substitute path having a high transmission rate with the video monitoring center 50 during the specific period.

This embodiment does not concretely describe the values of the compression rate in the specific period and in the period other than the specific period.

However, when the processing that enables discrimination of the occurrence of the event is accomplished on the basis of the interframe correlation, for example, such a compression rate may be an arbitrary value so long as quality adaptable to both, or either one, of the value representing the result of the interframe correlation and the train of such values and the quality (including the transmission quality) to be required for the image information can be accomplished.

This embodiment is accomplished by modifying the construction of the first embodiment described already.

However, the present invention is not limited to the first embodiment. In other words, this embodiment can be achieved by similarly modifying the construction of the second or third embodiment.

When the present invention is applied to the third embodiment, resolution of the partial image information to be transmitted to the video monitoring center 91 may be set to a high value so long as the increase of the traffic of the network 80 and the increase of the load to each part of the terminal equipment 40B-C and the video monitoring center 91 is allowable.

Next, the fifth embodiment of the present invention will be explained.

The structural features of this embodiment are that terminal equipment 40D-1 to 40D-N is provided in place of the terminal equipment 40A-1 to 40A-N and a video monitoring center 50A is provided in place of the video monitoring center 50.

The structural feature of the terminal equipment 40D-41 is that a controlling part 42A-1 is provided in place of the controlling part 42-1.

Incidentally, the construction of the terminal equipment 40D-2 to 40D-N is the same as the construction of the terminal equipment 40D-1. Therefore, suffixes “2” to “N” will be allotted to the corresponding constituents and explanation and illustration of such constituents will be omitted.

The structural feature of the video monitoring center 50A is that a controlling part 51A is provided in place of the controlling part 51.

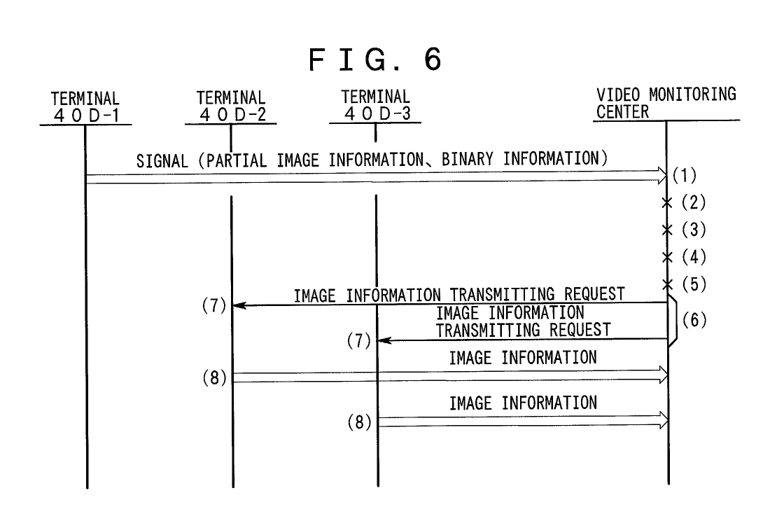

FIG. 6 is a diagram useful for explaining the operation of the fifth embodiment according to the present invention.

Hereinafter, the operation of the fifth embodiment of the present invention will be explained with reference to FIGS. 4 and 6.

The feature of this embodiment from the second embodiment resides in the procedure of a series of the following processing that the controlling part 42A-1 provided to the terminal equipment 40D-C and the controlling part 51A provided to the video monitoring center 50A execute in cooperation with each other.

Incidentally, suffix “C, that is applicable to any of the suffixes 1” to “N”, will be allotted to the matter common to the terminal equipment 40D-1 to 40D-N in place of these suffixes.

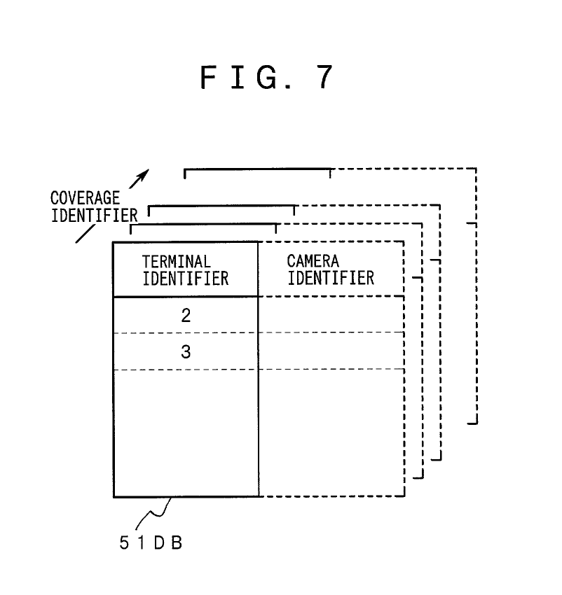

A coverage data base 51DB, to which a group of terminal identifiers representing the terminal equipment including therein the individual cameras for imaging a single or a plurality of coverages, that are physically adjacent to the coverages represented by photogenic-zone identifiers among the cameras 60-1 to 60-N, is in advance registered in such a fashion as the correspond to the coverage identifiers is disposed in the specific memory area of the main storage of the controlling part 51A provided to the video monitoring center 50A as shown in FIG. 7.

It will be assumed hereby for simplicity that the terminal identifiers are equal to the suffixes “1 ”to “N” allotted to the symbol “40D” of the terminal equipment 40-1 D to 40D-N.

Receiving a signal from the terminal equipment 40D-1 through the network 80, for example, the video decoding part 91 in the video monitoring center 50A de-multiplexes the signal to restore the image information and the binary information (FIG. 6(1)), gives the image information and the binary information to the advanced image processing part 92 (FIG. 6(2)) and gives also the terminal identifier (=1) representing the transmitting party specified under communication control adaptive to the network 80 together with the binary information to the controlling part 51A (FIG. 6(3)).

Only when the discrimination result represented by the binary information is true, the advanced image processing part 92 discriminates whether or not the event is detected during the dynamic image processing, and notifies the result to the controlling part 51A

The controlling part 51A judges whether or not this discrimination result matches with the binary information corresponding to the result (FIG. 6(4)), and does not execute any particular processing when the discrimination result is true.

When this discrimination result is false, however, the controlling part 51A acquires the terminal identifier (such as “2” or “3”) (hereinafter called merely “neighborhood terminal identifier”) stored in the record corresponding to the coverage identifier (=1) representing the coverage of the camera (which is assumed hereby as the a single camera 60-1 for simplicity) disposed under control of the terminal equipment 40D1 represented by the terminal identifier (=1) inside the record of the coverage database 51DB (FIG. 6(5)).

The controlling part 51A transmits an image information transmitting request to the terminal equipment 40D-2 and 40D-3 corresponding individually to the neighborhood terminal identifiers through the video decoding part 91 and the network 80 (FIG. 6(6)).

Incidentally, suffix “c”, that is applicable to any of the suffixes “2 and “3”, will be allotted to the matters common to the terminal equipment 40D-2 and 40D-3 for simplicity in place of these suffixes in the following description.

Discriminating the image information transmitting request received through the network 80, the network interfacing part 73A-c in the terminal equipment 40Dc regards the discrimination result represented by the binary information as being true irrespective of the binary information given at that time by the simple image processing part 41-c (FIG. 6(7)) and transmits the image information given from the simple image processing part 41-c for a predetermined period to the video monitoring center 50A (FIG. 6(8)).

In other words, when the event discriminated by the simple image processing part 41-c in the terminal equipment 40D-1 is not discriminated in the video monitoring center 50A, the image information representing the images of the coverages adjacent to the coverage of the camera 60-1 under control of this terminal equipment 40D-1 is automatically transmitted to the video monitoring center 50A

Therefore, according to this embodiment, the video monitoring center 50A can discriminate with high probability the event that is not discriminated due to degradation and fluctuation of transmission quality occurring in the network 80 so long as the object as the cause of the occurrence of this event moves to the adjacent coverages described above even when the event is a spontaneous event.

In this embodiment, the terminal equipment capable of downloading the image information representing the images of the adjacent coverages is determined under initiative of the video monitoring center 50A

However, the present invention is not limited to the construction described above. For example, when the following construction is applied, the processing for transmitting the image information-downloading request may be achieved under initiative of the terminal equipment (41D-1).

a construction in which the video monitoring center 50A notifies the discrimination result “false” to the terminal equipment 41D-1 in place of the image information-downloading request;

a construction in which the coverage database 51DB is dispersedly provided to the terminal equipment 41D-1 to 41D-N for each record that corresponds to the individual coverage identifier;

a construction in which the terminal equipment 41D-1 discriminates the discrimination result false” notified by the video monitoring center 50A and then transmits the image information-downloading request either directly or by the relay made by the video monitoring center 50A through the network 80 to the terminal equipment 40D-2 and 40D-3 represented by the neighborhood terminal identifiers included in these records.

The processing for transmitting the image information-downloading request may be executed under initiative of the camera 60-1 while the video monitoring center 50A and the terminal equipment 40D-1 to 40D-N opposing each other through the network 80 cooperate with each other.

In each of the embodiments described above, a single camera is disposed under the command of each terminal equipment 40-1 to 40-N, 40A-1 to 40A-N, 40B-1 to 40B-N, 40C-1 to 40C-N and 40D-1 to 40D-N, respectively.

However, the present invention is not limited to the construction described above. For example, a plurality of cameras may be disposed under the command of each terminal equipment 40-1 to 40-N, 40A-1 to 40A-N, 40B-1 to 40B-N, 40C-1 to 40C-N and 40D-1 to 40D-N so long as the following conditions are satisfied.

a condition where the video coding parts 71-C and 71-A-C, the simple image processing parts 41-C, 41A-C and 41B-C, the network interfacing parts 73-C and 73-A-C, and the controlling parts 42-C and 42A-C have a throughput and performance capable of accommodating a plurality of cameras; and

a condition where the individual records constituting the coverage database 51DB or the individual records distributed to the terminal equipment 40-1 to 40-N, 40A-1 to 40A-N, 40B-1 to 40B-N, 40C-1 to 40C-N and 40D-1 to 40D-N (cameras 60-1 to 60-N) and corresponding to an equivalent group of the coverage database 51DB comprise the fields representing the terminal identifiers and the fields representing unique camera identifiers that in turn represent individually a plurality of cameras accommodated under the command of the terminal equipment represented by the terminal identifier, as directed by dotted lines in FIG. 7.

In each of the foregoing embodiments, the value of the terminal identifier (and the value of the camera identifier) stored in advance in the coverage database 51DB is not at all updated.

However, the present invention is not limited to the construction described above. For example, when the coverages imaged by all, or a part, of the cameras 60-1 to 60-N can change, the value of the terminal identifier (and the value of the camera identifier) corresponding to the substantial position of the photogenic zones may be updated appropriately.

The forms of functional distribution and load distribution of the processing for updating the value of such a terminal identifier (and the value of the camera identifier), and the procedure and the operand of the processing may be arbitrary, and a man-machine interface may further be established appropriately during such a processing.

In each of the embodiments described above, the description of the processing to be executed by each part in cooperation with each other to assist the work of the operation and maintenance process in the video monitoring system is omitted.

However, the present invention is not limited to the construction described above. For example, all, or a part, of the video monitoring centers 50, 50A, the terminal equipment 40-1 to 40-N, 40A-1 to 40A-N, 40B-1 to 40B-N, 40C-1 to 40C-N and 40D-1 to 40D-N and the cameras 60-1 to 60-N may operate in cooperation with one another under an appropriate man-machine interface executed at each part or may operate individually.

The invention is not limited to the above embodiments and various modifications may be made without departing from the spirit and the scope of the invention. Any improvement may be made in part or all of the components.

What is claimed is:

1. A video broadcasting equipment comprising:
a communication interfacing section for forming a communication path to an image processing equipment which performs a dynamic image processing on image information which is given by a single or a plurality of camera(s) and individually represents images of coverages of the camera(s);
a dynamic-region discriminating section for discriminating a dynamic region of said image information individually representing the images of said coverages of said single or plurality of camera(s); and
a controlling section for transmitting said image information and a result of said discriminating to said image processing equipment through said communication path.

2. The video broadcasting equipment according to claim 1, further comprising a coding section for interframe coding said image information and generating a train of codes representing said image information, and wherein:
said dynamic-region discriminating section discriminates said dynamic region according to a difference between a prescribed threshold value and either or both of information content of said train of codes or/and a word length of codes constituting said train of codes; and
said controlling'section transmits said train of codes as image information to said image processing equipment, together with said discrimination result.

3. The video broadcasting equipment according to claim 1, further comprising a coding section for interframe coding image information including said discriminated dynamic region at a higher compression rate, compared with image information including no dynamic region, and for generating a train of codes representing said image information including said discriminated dynamic region, and wherein
said controlling section transmits said train of codes as image information to said image processing equipment, together with said discrimination result.

4. The video broadcasting equipment according to claim 1, wherein said controlling section transmits, as a discrimination result, a combination of identifiers of image information having a dynamic region discriminated by said dynamic-region discriminating section, to said image processing equipment together with said image information.

5. The video broadcasting equipment according to claim 1, wherein said controlling section transmits only image information including said discriminated dynamic region to said image processing equipment.

6. The video broadcasting equipment according to claim 4, wherein said controlling section transmits individual image information and individual discrimination results of said image information to said image processing equipment as superimposed image information.

7. The video broadcasting equipment according to claim 5, wherein said controlling section transmits individual image information and individual discrimination results of said image information to said image processing equipment as superimposed image information.

8. The video broadcasting equipment according to claim 1, wherein said controlling section transmits image information inclu ding sa id discri minated dynamic region to said image processing equipment with higher resolution, compared with image information including no dynamic region.

9. The video broadcasting equipment according to claim 1, wherein said controlling section transmits, to said image processing equipment , image information including said discriminated dynamic region at a higher transmission rate, compared with image information including no dynamic region.

10. The video broadcasting equipment according to claim 9, wherein said communication interfacing section sets a transmission rate of a communication path used for transferring image information including said discriminated dynamic region, to a higher value, compared with a communication path used for transferring image information including no dynamic region.

11. The video broadcasting equipment according to claim 1, further comprising dynamic-region extracting section for extracting partial image information including said individual discriminated dynamic regions from said image information given by said single or plurality of camera(s), and wherein
said controlling section transmits said partial image information to said image processing equipment, together with said discrimination result.

12. The video broadcasting equipment according to claim 8, wherein said controlling section transmits image information including said discriminated dynamic region to said image processing equipment at a higher compression rate, compared with image information including no dynamic region.

13. The video broadcasting equipment according to claim 1, wherein said controlling section transmits image information which is assigned through said communication path, to said image processing equipment.

14. The video broadcasting equipment according to claim 13, further comprising a storage section where an identifier of a camera which images adjacent coverage(s) of said single or plurality of camera(s) is registered in advance, and wherein
said controlling section specifies a camera, which has an identifier registered in said storage section, corresponding to a coverage of a camera designated by said image processing equipment, and transmits image information given from said specified camera to said image processing equipment.

15. The video broadcasting equipment according to claim 1, wherein said controlling section gives a notification of being assigned to a specific camera assigned through a communication path, and transmits image information given from the specific camera to said image processing equipment.

16. An image processing equipment comprising:
a communication interfacing section for receiving image information which is given through a communication path and individually represents images of coverages of a single or a plurality of camera(s) and a discrimination result of as to whether or not the image information includes a dynamic region;
an image selecting section for selecting image information whose discrimination result is true, from the received image information; and
an image processing section for executing dynamic image processing on said selected image information.

17. The image processing equipment according to claim 16, wherein said image processing section discriminates dynamic regions of image information selected by said image selecting section.

18. The image processing equipment according to claim 17, wherein said image processing section performs all or a part of:
detection of a size, a shape, and a movement pattern of an object positioned in each of said discriminated dynamic regions;
tracing of the object positioned in each of said discriminated dynamic regions;
detection of a change in image structure; and
detection of an object disappearing from the dynamic regions.

19. The image processing equipment according to claim 17, wherein said image processing section determines either or both of a speed or/and a moving direction of an object positioned in each of said discriminated dynamic regions.

20. The image processing equipment according to claim 18, wherein said image processing section determines either or both of a speed or/and a moving direction of an object positioned in each of said discriminated dynamic regions.

21. The image processing equipment according to claim 17, wherein said image processing section transmits a download request of substitute image information to said video broadcasting equipment capable of downloading the substitute image information, through said communication interfacing section and said communication path, when a dynamic region of any image information selected by said image selecting section cannot be discriminated.

22. The image processing equipment according to claim 21, wherein said image processing section transmits specific image information other than image information having no dynamic region discriminated, or an identifier representing a camera which outputs the specific image information as said download request of substitute image information.

23. The image processing equipment according to claim 21, further comprising a storage section where an identifier of a camera which images adjacent coverage(s) of said single or plurality of camera(s) is registered in advance, and wherein
said image processing section specifies a coverage where an image including no dynamic region is imaged, and requests a download of substitute image information imaged by a camera having an identifier of the specified coverage registered in said storage section, through said communication interfacing section and said communication path.

24. The image processing equipment according to claim 22, further comprising a storage section where an identifier of a camera which images adjacent coverage(s) of said single or plurality of camera(s) is registered in advance, and wherein
said image processing section specifies a coverage where an image including no dynamic region is imaged, and requests a download of substitute image information imaged by a camera having an identifier of the specified coverage registered in said storage section, through said communication interfacing section and said communication path.

25. The image processing equipment according to claim 16, further comprising man-machine interfacing section for specifying a camera from said single or plurality of camera(s) under man-machine interface, and requesting a download of said image information to the specified camera through said communication interfacing section and said communication path.

26. The image processing equipment according to claim 25, wherein said man-machine interfacing section requests the download of said image information to be performed at all or a part of resolution, compression rate, and transmission rate set under said man-machine interface.

27. A camera comprising:
an imaging section for imaging an image of a coverage and generating image information representing the image;
a coverage judging section wherein a relative position of said coverage to the coverages of other cameras is given in advance, for judging whether or not the relative position corresponds to adjacent coverages of a coverage assigned from outside; and
a controlling section for outputting said image information generated by said imaging section when a judgement result from said coverage judging section is true.
